(19) United States
(12) Patent Application Publication
(10) Pub. No.: US 2003/0229743 A1
(43) Pub. Date: Dec. 11, 2003

(54) Methods and structure for improved fairness bus arbitration

(76) Inventor: Andrew C. Brown, Colorado Springs, CO (US)

Correspondence Address: LSI LOGIC CORPORATION, 1621 BARBER LANE, MS: D-106 LEGAL, MILPITAS, CA, 95035, US

(21) Appl. No.: 10/162,960

(22) Filed: Jun. 5, 2002

(51) Int. Cl. G06F 13/36

(52) U.S. Cl. 710/113

(57) ABSTRACT

Methods and structure for enhanced bus arbitration providing a priority-based arbitration technique with improved fairness for lower priority devices. In particular, the invention provides a masking feature within the bus arbiter such that all devices simultaneously requesting temporary exclusive control of the shared bus are remembered in the mask when a bus grant is made to a first requesting master device. When the first master device relinquishes control of the bus, remembered master devices are first granted temporary exclusive control of the bus (preferably in priority order) prior to any non-remembered master devices presently requesting the bus. When all remembered master devices have been granted an opportunity for temporary exclusive control of the bus, the mask identifying remembered master devices is cleared and standard priority-based arbitration techniques resume.

### RELATED PATENTS

This patent is related to co-pending, commonly owned U.S. patent application Ser. No. 01-829, filed (concurrently herewith), entitled METHODS AND STRUCTURE FOR STATE PRESERVATION TO IMPROVE FAIRNESS IN BUS ARBITRATION and is related to co-pending, commonly owned U.S. patent application Ser. No. 01-831, filed (concurrently herewith), entitled METHODS AND STRUCTURE FOR DYNAMIC MODIFICATIONS TO ARBITRATION FOR A SHARED RESOURCE, both of which are hereby incorporated herein by reference.

### BACKGROUND OF THE INVENTION

1. Field of the Invention

The present invention relates to bus arbitration and in particular to a bus arbitration method and structure for improving fairness in priority-based allocation of a shared bus among multiple requesting master devices.

2. Discussion of Related Art

It is generally known in electronic systems to have multiple devices communicating over a shared electronic bus. In general, a first device (usually referred to as a master device) initiates an exchange of information with a second device (usually referred to as a slave device). It is also generally known in the art that a bus structure may permit multiple master devices and multiple slave devices to exchange information. Generally, one master device communicates with one or more slave devices to the exclusion of other master and slave devices in the system. In such a circumstance, a first master device desiring use of the bus for communication with a slave device must first obtain temporary exclusive control over the shared bus structure. A master device obtains temporary exclusive control of the shared bus by requesting the bus structure and awaiting an acknowledgment signal indicative of granting of the requested temporary exclusive access to the shared bus.

Typically, an arbiter device coupled to the shared bus structure receives a request for temporary exclusive control of the bus from each of several master devices and selects the next master device to obtain the requested temporary exclusive control. The arbiter receives request signals and returns grant (acknowledgment) signals to master devices to indicate request and granting of temporary exclusive control, respectively. This process is typically referred to as the bus arbitration. A number of well-known commercially applied bus structures support such multiple master devices sharing control of a bus. Though the specific timing and signals involved in arbitration may vary, all such buses support arbitration in some form.

It is common in the art for an arbiter device to utilize any of several well-known techniques for determining the next requesting master device to be granted temporary exclusive control of the shared bus structure. One simple technique is often referred to as “round-robin” in that each device may be granted temporary exclusive control of the shared bus in sequential order defined by an index number—usually a master device ID. When the last master device ID is granted temporary exclusive control over the bus, the first master device is again eligible for exclusive bus control. This sequential “round-robin” technique assures that each master device has a roughly equal opportunity to obtain temporary exclusive control of the shared bus structure.

Another common bus arbitration technique is to assign a priority to each master device. At any given point, a master device with the highest priority requesting temporary exclusive control of the shared bus will be granted control over the bus. Still other techniques combine features of both a priority-based scheme and round-robin arbitration techniques. For example, each master device may be assigned a priority and all master devices having the same particular priority level share the bus using a round-robin technique.

Strict round-robins arbitration generally provides equal access to the shared bus for all master devices. Standard priority-based bus arbitration algorithms are effective at assuring that the highest priority master devices can rapidly access the shared bus as compared to lower priority devices. However a problem with priority-based scheme is that the lowest priority devices may be effectively “starved” from access to the bus due to high frequency bus requests by higher priority master devices. By contrast, round-robin arbitration techniques preclude high priority master devices from obtaining necessary frequent access to a shared bus.

It is evident from the above discussion that a need exists for improved arbitration techniques that provide additional fairness to lower priority master devices while granting frequent access to high priority master devices.

### SUMMARY OF THE INVENTION

The present invention solves the above and other problems, thereby advancing the state of the useful arts, by providing a priority-based arbitration technique with improved fairness for periodic allocation of the shared bus to lower priority master devices. More specifically, the present invention utilizes masking techniques and structures to remember all devices simultaneously requesting temporary exclusive control of the bus whenever a particular higher priority master device is granted the bus. When the higher priority master device relinquishes its temporary exclusive control of the bus, the “remembered” master devices are granted temporary exclusive control of the bus before other devices generating new bus requests. Within the subset of remembered requesting master devices, a standard priority-based algorithm is applied such that the highest priority master device within the group of remembered devices is granted temporary exclusive control of the bus first. Once all remembered master devices are granted control of the bus and relinquish it, the mask preventing other devices from obtaining such temporary exclusive control is reset and standard priority-based arbitration resumes for all master devices.

A first feature of the invention therefore provides a method in a system having multiple master devices coupled to a shared bus, the method comprising the steps of: detecting multiple bus requests from multiple requesting devices of the multiple master devices such that the multiple bus requests are detected substantially simultaneously; granting the bus to a first requesting device of the multiple requesting devices; remembering the multiple requesting devices; and granting, responsive to the step of remembering, the bus to other requesting devices of the multiple requesting devices before granting bus requests from other devices of the multiple master devices.

Another aspect of the invention further provides that the step of granting the bus to the first requesting device includes the step of selecting the first requesting device from the multiple requesting devices using a round-robin method, and that the step of granting the bus to the other requesting devices includes the step of granting the bus to each of the other requesting devices using a round-robin method.

Another aspect of the invention further provides that each master device of the multiple master devices coupled to the bus has an associated priority value and that the step of granting the bus to the first requesting device includes the step of selecting the first requesting device from the multiple requesting devices as the highest priority device of the multiple requesting devices, and that the step of granting the bus to the other requesting devices includes the step of granting the bus to each of the other requesting devices in order of highest to lowest priority value of each of the other requesting devices.

Another aspect of the invention further provides for detecting relinquishment of the bus by the first requesting device, such that the step of remembering is responsive to the detection of the relinquishment.

Another aspect of the invention further provides that the step of remembering includes the step of setting a mask value indicative the other requesting devices, and that the step of granting the bus to the other requesting devices includes the steps of: a) granting the bus to a next requesting device of the other requesting devices indicated by the mask value; b) updating the mask value to eliminate the next requesting device; and c) repeating steps a) and b) until no further devices of the other requesting devices are indicated by the mask value.

Another aspect of the invention further provides for detecting relinquishment of the bus by the first requesting device, such that the step of remembering is responsive to the detection of the relinquishment.

Another aspect of the invention further provides that the step of granting the bus to the other requesting devices includes the step of: detecting relinquishment of the bus by the next requesting device, such that the step of updating is responsive to the detection of the relinquishment by the next requesting device.

Another feature of the invention provides for a system comprising: a shared resource; a plurality of master devices coupled to the shared resource such that each master device generates requests for temporary exclusive access to the shared resource; and an arbiter for controlling grants of requested temporary exclusive access to the shared resource by the plurality of master devices such that the arbiter includes: a memory element for remembering pending requests for temporary exclusive access by master devices of the plurality of master devices at the time of granting a request by one master device of the plurality of master devices; and a request grant element coupled to the memory element for granting a pending request for temporary exclusive access by a master device of the plurality of master devices in accordance with information in the memory element.

Another aspect of the invention further provides that the memory element further comprises: a bit mask having a plurality of bits such that each bit of the plurality of bits corresponds to a master device of the plurality of master devices.

Another aspect of the invention further provides that the request grant element is operable to grant remembered pending requests before new requests from other master devices.

Another aspect of the invention further provides that each master device of the plurality of master devices has a priority attribute associated therewith and such that the request grant element is further operable to grant the highest priority remembered pending request before lower priority remembered pending requests.

### BRIEF DESCRIPTION OF THE DRAWINGS

FIG. 1 is a block diagram of a typical system employing the enhanced arbitration features of the present invention.

FIG. 2 is a flowchart describing an exemplary method of the present invention to improve fairness in priority-based bus arbitration.

FIG. 3 is a timing diagram showing exemplary, approximate timings for an exemplary preferred embodiment of the improved fairness arbiter of the present invention.

### DETAILED DESCRIPTION OF THE PREFERRED EMBODIMENTS

While the invention is susceptible to various modifications and alternative forms, a specific embodiment thereof has been shown by way of example in the drawings and will herein be described in detail. It should be understood, however, that it is not intended to limit the invention to the particular form disclosed, but on the contrary, the invention is to cover all modifications, equivalents, and alternatives falling within the spirit and scope of the invention as defined by the appended claims.

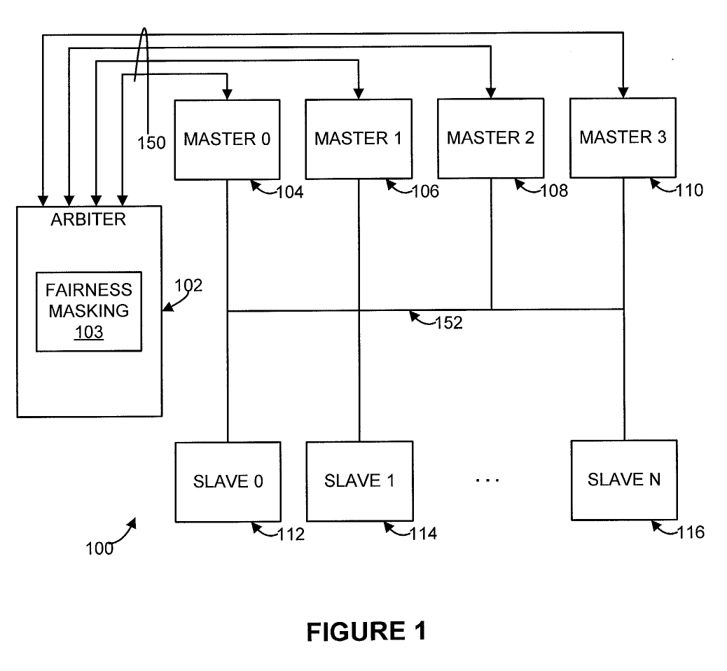

FIG. 1 is a block diagram of a system 100 having multiple master devices 104 through 110 and multiple slave devices 112 through 116 coupled to a shared system bus 152. Arbiter 102 includes fairness masking element 103 in accordance with the present invention to improve fairness of granting of temporary exclusive ownership of the common share bus 152 to any of multiple masters 104 through 110.

Request and grant signals associated with each master device 104 through 110 are exchanged with arbiter 102 via bus 150. In general, each master device 104 through 110 requests temporary exclusive control of bus 152 by applying a bus request signal to its associated signal path of bus 150. The arbiter 102 receives all such bus request signals from all master devices 104 through 110 and selects the next master device presently requesting temporary exclusive ownership of bus 152 to which the requested ownership will be granted. A grant signal is applied to an associated signal path of bus 150 to grant the request of the next selected master device.

As noted above, any of several well-known arbitration techniques may be used within arbiter 102 including, for example, round-robin arbitration whereby each master device 104 through 110 receives essentially equal opportunity for allocation of temporary exclusive ownership of bus 152. In addition, where particular master devices perform more critical operations, priority-based arbitration schemes are common within arbiter 102. In a priority-based arbitration architecture, each master devices is associated with a particular priority level. When multiple master devices simultaneously request temporary ownership of bus 152, arbiter 102 selects the highest priority such requesting master device to receive the requested temporary exclusive ownership of bus 152. At any given priority level, multiple master devices having the same priority level may be granted temporary exclusive ownership by application of a round-robin arbitration schemes within the priority level.

As noted above, in such priority-based arbitration architectures, lower priority master devices may be “starved” from temporary exclusive ownership of the shared bus by higher priority devices frequently requesting and receiving temporary exclusive ownership of the bus. Specifically, a lower priority master cannot receive a grant of the bus unless and until all higher priority master devices are not simultaneously requesting the bus. If higher priority devices frequently request the bus, the lower priority device may never receive a grant of temporary exclusive ownership corresponding to his outstanding request for the bus. In this sense, round-robin based arbitration provides complete fairness and equality in allocating bus grants to multiple master devices but does not permit prioritization of simultaneous bus requests. By contrast, prioritization of bus requests by multiple master devices provides the desired rapid response for high priority devices but does not assure any fairness for allocation of the bus to lower priority master devices.

Fairness masking element 103 within arbiter 102 provides improved fairness in bus arbitration when used in conjunction with priority-based arbitration architectures. In general, as noted above, fairness masking element 103 ensures that all master devices simultaneously requesting temporary exclusive ownership of bus 152 at some point in time will eventually receive the requested control before any subsequent master device requests are serviced.

More specifically, fairness masking element 103 preferably generates a mask value indicating all master devices simultaneously requesting the bus at the time the bus is granted to the highest priority master device of the multiple requests. When the highest priority master device relinquishes its exclusive control, all master devices indicated by the saved mask value will first be granted their respective requested exclusive control before any later requesting master devices (i.e., those master devices not indicated by the saved mask value).

Those skilled in the art will recognize that the architecture depicted in FIG. 1 is intended as exemplary of a wide variety of bus architectures that may benefit from the improved fairness techniques and structure of the present invention. In particular, those skilled in the art will recognize that any number of master devices may be used in conjunction with such a system structure limited only by the specifications of the particular system bus selected by the designer. Further, any number of slave devices, limited only by the requirements and specifications of the selected system bus, may be present in such a system 100.

Still further, those of ordinary skill in the art will recognize that any of several well-known system bus architectures may be selected for a system bus 152 and arbitration signals on bus 150. In particular, in one exemplary preferred embodiment, bus 150 and 152 together may be an AMBA AHB compliant high-performance system bus architecture. A number of other common, commercial bus structures may also benefit from the features of the present invention including, for example, PCI, PCI-X and other embedded and custom/proprietary buses that require bus arbitration. Those skilled in the art will further recognize that signals applied to bus 150 and system bus 152 are typically integrated in a single bus structure rather than two distinct bus structures as depicted in FIG. 1. Signals applied to bus 150 are shown in FIG. 1 as separate from system bus 152 only to simplify the description in that signals applied to bus 150 relate exclusively to bus arbitration processing to exchange signals between master devices 104 through 110 and arbiter 102.

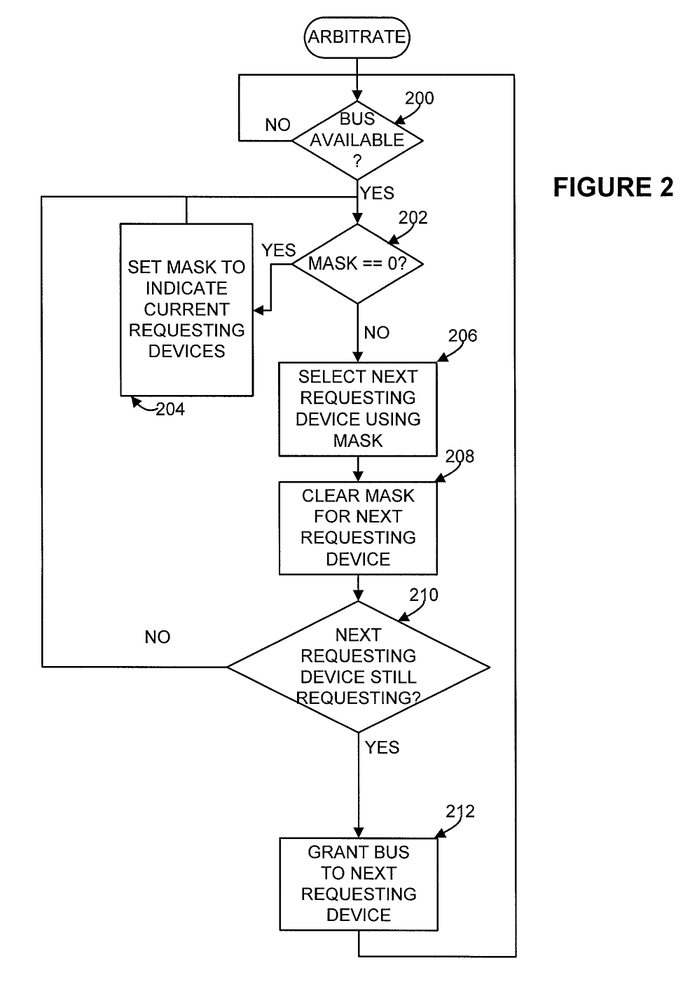

FIG. 2 is a flowchart describing the operation of an exemplary embodiment of fairness masking element 103 of FIG. 1. A more detailed description of the structure and function of one exemplary preferred embodiment of fairness masking element 103 is provided herein below in the form of an HDL design description. FIG. 2 is therefore intended as a description of the general operation of one exemplary preferred embodiment of fairness masking element 103.

Element 200 of FIG. 2 is first operable within the arbiter to determine whether the shared system bus is presently available. If not, processing continues by looping on element 200 until the shared system bus is available—i.e., relinquished by the present owner. When the system bus is available, element 202 next tests the saved fairness mask value to determine if any master devices previously requesting the bus need be serviced before new bus requests are processed. If no previously requesting master devices remain to be serviced as indicated by the saved mask value, element 204 is next operable to determine what if any master devices are presently requesting temporary exclusive ownership of the shared bus. In particular, the mask value is set to indicate all master devices presently requesting control of the system bus. Processing then returns to element 202 to determine if any devices are presently requesting the bus. If not, elements 202 and 204 continue iteratively until the mask value indicates that one or more master devices are currently requesting temporary exclusive ownership of the bus.

When element 202 determines that some master devices are presently requesting temporary exclusive control of the system bus, element 206 is next operable to select a next requesting master device from those devices indicated by the mask value as presently requesting temporary exclusive ownership of the bus. The particular algorithm used to select a next master device to receive a grant of temporary exclusive ownership of the bus is a matter of design choice for those of ordinary skill in the art. In this first exemplary preferred embodiment, the highest priority device requesting the bus of those indicated by the mask value is first selected by operation of element 206. Element 208 then clears the indicator in the mask value indicative of an outstanding bus request by the selected master device.

Element 210 next determines whether the selected master device is still requesting temporary exclusive ownership of the bus. In some system bus architectures it is possible for a master device to request temporary exclusive ownership of the system bus and then later drop the request without having received a corresponding grant. Timeout or other system events or errors may be the reason for dropping a pending bus request. If element 210 determines that the selected device is no longer requesting temporary exclusive ownership of the bus, processing continues by looping back to element 202 to process other pending bus requests or to await receipt of new bus requests.

If element 210 determines that they selected master device is still requesting temporary exclusive ownership of the bus, element 212 is next operable to grant the requested temporary exclusive ownership to the selected master device. Processing and then continues by looping back to element 200 as indicated above awaiting relinquishment of temporary exclusive control of the bus by the selected master device.

In general, elements 202 and 206 through 212 are iteratively operable to process arbitration for all master devices that simultaneously request temporary exclusive ownership of the bus before receiving and processing new bus requests from other master devices. In this manner, lower priority devices will be assured some degree of fairness in the allocation of temporary exclusive ownership of the shared system bus structure. So long as a lower priority device has requested temporary exclusive ownership and has not dropped its request, it is assured that it will eventually receive the requested temporary exclusive ownership of the system bus.

Those skilled in the art will recognize that the flowchart of FIG. 2 is intended as a broad functional description of methods of the present invention operable within an improved fairness arbiter. Numerous equivalent techniques will be readily apparent to those of ordinary skill in the art to provide similar fairness by assuring lower priority devices that an outstanding bus request will eventually be granted despite frequent bus requests by higher priority devices. Further, those skilled in the art will recognize that the mask value may be implemented by any of a number of equivalent circuit and software design structures. Selection among such equivalent structures is a well-known matter of design choice for those of ordinary skill in the art.

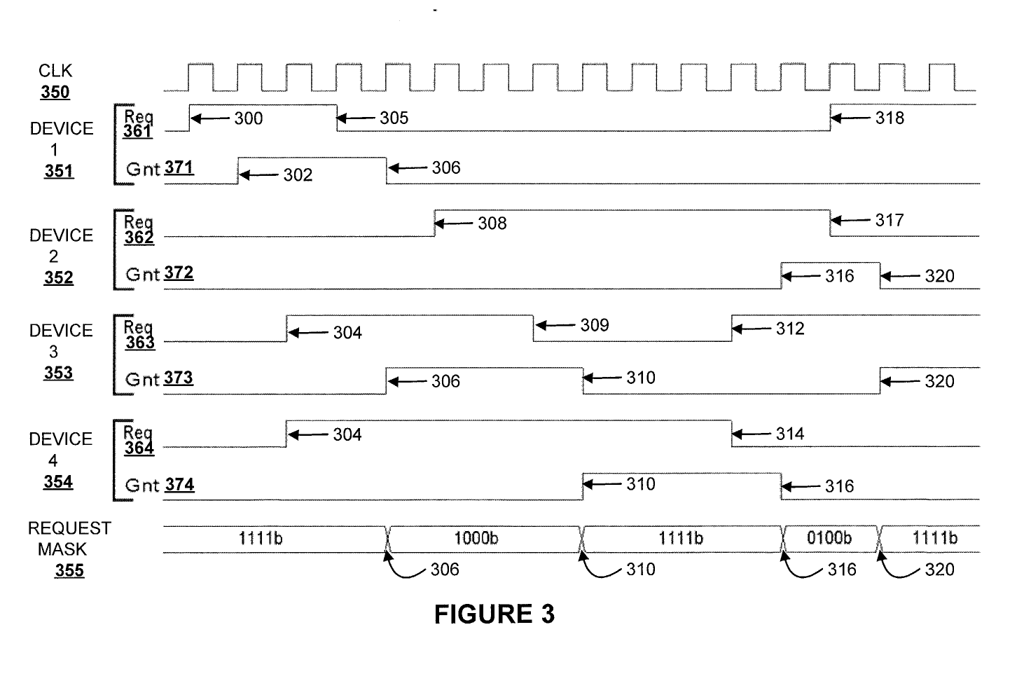

FIG. 3 is an exemplary timing diagram describing operation of one exemplary preferred embodiment of an arbiter with improved fairness in accordance with the present invention. Clock signal 350 is shown at the top as a ubiquitous clock signal applied to logic circuits within the bus arbiter of the present invention. The specific clock edge relationships with other signals are not intended to be precise in the depiction of FIG. 3 but rather merely suggestive of exemplary timing. Those skilled in the art will readily recognize a variety of equivalent timing relationships among the various signals shown with respect to the ubiquitous clock signal 350.

Signals related to master device 1 (351), the highest priority master device, include a bus request signal 361 and a corresponding bus grant signal 371. In like manner, signals associated with a second master device (352), the second highest priority device, include bus request 362 and bus grant 372. Signals for master device 3 (353) include bus request 363 and bus grant 373. Lastly master device 4 (354), the lowest priority device, includes a bus request signal 364 and a bus grant signal 374.

Request mask 355 is preferably a four bit wide signal path with one bit corresponding to each of the four identified master devices. The bit for each master device indicates that the corresponding device is remembered as having an outstanding request at the time of the last bus grant. This request mask 355 represents one exemplary embodiment of the improved fairness structure of the present invention whereby all devices are assured of fairness in allocation of temporary exclusive control of the shared bus while permitting prioritized bus requests and grants.

All signals are depicted as timelines with time increasing from left to right in the figure. At time indicator of 300, master device 1 applies a signal to its bus request 361 to request temporary exclusive ownership of the shared system bus. At this time (300), master device 1 is the only device requesting the bus. The request mask 355 therefore indicates no other master devices are to be remembered as pending requests at the time of bus grant to master device 1. In the depicted, exemplary preferred embodiment, a condition of no outstanding requests is indicated as a value of all 1's in request mask 355. This design choice simplifies certain gate logic used to evaluate the remembered pending requests (if any). Those skilled in the art will readily recognize that a value of all 0's may be equivalently selected with appropriate logic to apply the mask value.

At time indicator 302, master device 1 is granted the bus as indicated by assertion of the corresponding grant signal 371. At time indicator 304 master devices 3 and 4 (substantially simultaneously) request temporary exclusive control of the bus by application of their bus request signals, 363 and 364, respectively. Since master device 1 presently has temporary exclusive ownership of the system bus, bus requests for master devices 3 and 4 remain pending until the bus is again available. At time indicator 305 master device 1 completes its temporary exclusive use of the bus and drops its assertion of bus request signal 361. Shortly thereafter, at time indicator 306, the arbiter drops the bus grant signal 371 thereby freeing the shared system bus for granting to another requesting master device. Substantially simultaneously, the arbiter grants the bus to master device 3 which had previously requested the bus along with master device 4. Since master device 3 is higher priority than device 4, it receives grant of the bus next. However, it will be noted that substantially simultaneously, request mask 355 is set with a bit value indicating that master device 4 remains pending as a previous bus request at the time the bus is granted to master device 3.

At time indicator 308, while master device 3 still has temporary exclusive ownership of the bus, master device 2 applies a signal to its bus request 362 requesting temporary exclusive ownership of the bus. This request remains pending while master device 3 controls the bus. At time indicator 309, master device 3 has completed its use of the bus and drops its assertion of bus request 363. Later, at time indicator 310, the arbiter drops the grant signal 373 for master device 3 and determines a next master device to receive temporary exclusive ownership of the bus. Without the improvements of the present invention, master device 2 has a higher priority request than master device 4 and would next receive a grant of the share bus. However, the request mask 355 signal of the improved arbiter of the present invention indicates that master device 4 had previously requested the bus prior to the request by master device 2. Specifically, request mask 355 indicates that master device 4 has a pending bus request and request signal 364 indicates that the bus request remains active. Therefore, the improved arbiter at time indicator 310 next applies a grant signal to bus grant 374 granting the temporary exclusive ownership of the bus to master device 4 rather than the higher priority requesting master device 2. Still further at time indicator 310, the bit in request mask 355 indicating an outstanding request for master device 4 is cleared such that the request mask no longer indicates any outstanding request pending from the earlier time indicator 304.

At time indicator 312, while master device 4 continues with its exclusive ownership of the bus, master device 3 applies another signal to request 363 indicating a renewed need for temporary exclusive ownership of the bus. At time indicator 314, master device 4 indicates its completion of temporary exclusive control of the bus by dropping its assertion of bus request signal 364. At time indicator 316, the arbiter detects that request mask 355 indicates no further pending earlier requests remain to be serviced and therefore tests for new outstanding bus request signals. The arbiter finds that master device 2 has asserted its request signal 362 and master device 3 has also asserted its request signal 363. Master device 2, as the higher priority master device, is therefore next granted temporary exclusive ownership of the bus by application of a signal to bus grant 372. Simultaneously, request mask 355 is updated to reflect a currently outstanding request by master device 3. At time indicator 317 master device 2 has completed its temporary use and control of the bus and drops its assertion of request signal 362 before temporary exclusive control has been fully relinquished. At time indicator 318, master device 1 (the highest priority device) again asserts its need for temporary exclusive control and applies a signal to its bus request 361. At time indicator 320, the arbiter removes temporary exclusive control from master device 2 my dropping bus grant signal 372. Substantially simultaneously the arbiter recognizes that request mask 355 indicates a previously asserted, still pending, bus request by master device 3 and applies a signal to bus grant 373 thereby granting master device 3 temporary exclusive control of the bus. This despite the outstanding request from highest priority master device 1. Still further, request mask 355 is altered to remove the indication of an outstanding pending bus request by master device 3. The sequence may continue with other exemplary bus requests and corresponding bus grants based on priority bus arbitration enhanced with the fairness improvements of the present invention.

Those skilled in the art will readily recognize that the timing relationships depicted in FIG. 3 are intended merely as exemplary of signal timings that demonstrate the improved fairness features of the present invention when coupled with a priority-based arbitration architecture. Numerous other timing examples will be readily apparent to those of ordinary skill in the art. Further, those skilled in the art will recognize a variety of equivalent signaling and encoding techniques for generating request mask 355 signals. Encodings other than a bit mask field may be used. In addition, the mask bit values of 0 and 1 may be exchanged for different semantic interpretation. Such design choices are well-known to those of ordinary skill in the art.

The following hardware description language (HDL) listing provides a precise exemplary implementation of one preferred embodiment of the improved fairness of the present invention coupled with priority-based bus arbitration. In particular, the following HDL excerpts provide a description of portions of actual, synthesizable logic circuits for implementing an arbiter with the improved fairness techniques of the present invention as applied to an AMBA AHB bus architecture. Such an HDL description will be readily understood by those of ordinary skill in the art as a precise description of a preferred exemplary embodiment of an improved arbiter. Further, those of ordinary skill will recognize a variety of alternatives within the HDL description for expressing similar functionality and structures to achieve the same improved fairness feature.

While the invention has been illustrated and described in the drawings and foregoing description, such illustration and description is to be considered as exemplary and not restrictive in character, it being understood that only the preferred embodiment and minor variants thereof have been shown and described and that all changes and modifications that come within the spirit of the invention are desired to be protected.

What is claimed is:

1. In a system having multiple master devices coupled to a shared bus, a bus arbitration method comprising the steps of:
detecting multiple bus requests from multiple requesting devices of said multiple master devices wherein said multiple bus requests are detected substantially simultaneously;
granting said bus to a first requesting device of said multiple requesting devices;
remembering said multiple requesting devices; and
granting, responsive to the step of remembering, said bus to other requesting devices of said multiple requesting devices before granting bus requests from other devices of said multiple master devices.

2. The method of claim 1
wherein the step of granting said bus to said first requesting device includes the step of selecting said first requesting device from said multiple requesting devices using a round-robin method, and
wherein the step of granting said bus to said other requesting devices includes the step of granting said bus to each of said other requesting devices using a round-robin method.

3. The method of claim 1 wherein each master device of said multiple master devices coupled to said bus has an associated priority value and
wherein the step of granting said bus to said first requesting device includes the step of selecting said first requesting device from said multiple requesting devices as the highest priority device of said multiple requesting devices, and
wherein the step of granting said bus to said other requesting devices includes the step of granting said bus to each of said other requesting devices in order of highest to lowest priority value of each of said other requesting devices.

4. The method of claim 1 further comprising the step of:
detecting relinquishment of said bus by said first requesting device, wherein the step of remembering is responsive to the detection of said relinquishment.

5. The method of claim 1
wherein the step of remembering includes the step of setting a mask value indicative said other requesting devices, and
wherein the step of granting said bus to said other requesting devices includes the steps of:
a) granting said bus to a next requesting device of said other requesting devices indicated by said mask value;
b) updating said mask value to eliminate said next requesting device; and
c) repeating steps a) and b) until no further devices of said other requesting devices are indicated by said mask value.

6. The method of claim 5 further comprising the step of:
detecting relinquishment of said bus by said first requesting device, wherein the step of remembering is responsive to the detection of said relinquishment.

7. The method of claim 6 wherein the step of granting said bus to said other requesting devices includes the step of:
detecting relinquishment of said bus by said next requesting device,
wherein the step of updating is responsive to the detection of said relinquishment by said next requesting device.

8. A system comprising:
a shared resource;
a plurality of master devices coupled to said shared resource wherein each master device generates requests for temporary exclusive access to said shared resource; and
an arbiter for controlling grants of requested temporary exclusive access to said shared resource by said plurality of master devices wherein said arbiter includes:
a memory element for remembering pending requests for temporary exclusive access by master devices of said plurality of master devices at the time of granting a request by one master device of said plurality of master devices; and
a request grant element coupled to said memory element for granting a pending request for temporary exclusive access by a master device of said plurality of master devices in accordance with information in said memory element.

9. The system of claim 8 wherein said memory element further comprises:
a bit mask having a plurality of bits wherein each bit of said plurality of bits corresponds to a master device of said plurality of master devices.

10. The system of claim 8 wherein said request grant element is operable to grant remembered pending requests before new requests from other master devices.

11. The system of claim 10 wherein each master device of said plurality of master devices has a priority attribute associated therewith and wherein said request grant element is further operable to grant the highest priority remembered pending request before lower priority remembered pending requests.

12. In a system having multiple master devices coupled to a shared bus, a bus arbiter comprising:
means for detecting multiple bus requests from multiple requesting devices of said multiple master devices wherein said multiple bus requests are detected substantially simultaneously;
means for granting said bus to a first requesting device of said multiple requesting devices;
means for remembering said multiple requesting devices; and
means for granting, responsive to the means for remembering, said bus to other requesting devices of said multiple requesting devices before granting bus requests from other devices of said multiple master devices.

13. The arbiter of claim 12
wherein the means for granting said bus to said first requesting device includes means for selecting said first requesting device from said multiple requesting devices using a round-robin method, and
wherein the means for granting said bus to said other requesting devices includes means for granting said bus to each of said other requesting devices using a round-robin method.

14. The arbiter of claim 12 wherein each master device of said multiple master devices coupled to said bus has an associated priority value and
wherein the means for granting said bus to said first requesting device includes means for selecting said first requesting device from said multiple requesting devices as the highest priority device of said multiple requesting devices, and
wherein the means for granting said bus to said other requesting devices includes means for granting said bus to each of said other requesting devices in order of highest to lowest priority value of each of said other requesting devices.

15. The arbiter of claim 12 further comprising:
means for detecting relinquishment of said bus by said first requesting device, wherein the means for remembering is responsive to the detection of said relinquishment.

16. The arbiter of claim 12
wherein the means for remembering includes means for setting a mask value indicative said other requesting devices, and
wherein the means for granting said bus to said other requesting devices includes:
a) means for granting said bus to a next requesting device of said other requesting devices indicated by said mask value;
b) means for updating said mask value to eliminate said next requesting device; and
c) means for repeating operation of a) and b) until no further devices of said other requesting devices are indicated by said mask value.

17. The arbiter of claim 16 further comprising:
means for detecting relinquishment of said bus by said first requesting device, wherein the means for remembering is responsive to the detection of said relinquishment.

18. The arbiter of claim 17 wherein the means for granting said bus to said other requesting devices includes:
means for detecting relinquishment of said bus by said next requesting device,
wherein the means for updating is responsive to the detection of said relinquishment by said next requesting device.
